(19) United States
(12) Patent Application Publication
(10) Pub. No.: US 2017/0188622 A1
(43) Pub. Date: Jul. 6, 2017

(54) SMOKELESS TOBACCO PRODUCT

(71) Applicant: R.J. REYNOLDS TOBACCO COMPANY, WINSTION-SALEM, NC (US)

(72) Inventor: Vinson D. Wilson, Burlington, NC (US)

(73) Assignee: R.J. REYNOLDS TOBACCO COMPANY, WINSTION-SALEM, NC (US)

(21) Appl. No.: 14/988,096

(22) Filed: Jan. 5, 2016

(51) Int. Cl. A24B 15/28; B05D 7/24; B05D 1/12; A24F 23/02

(52) U.S. Cl. CPC A24B 15/283; A24F 23/02; B05D 7/24; B05D 1/12

(57) ABSTRACT

A container for a smokeless tobacco product includes a liquid-permeable pouch and a capsule coupled to the liquid-permeable pouch and containing an additive. The capsule releases the additive in response to a trigger condition associated with use of the smokeless tobacco product. The additive may comprise a flavorant configured to enhance the flavor of the smokeless tobacco product during use.

### BACKGROUND

Field of the Disclosure

The present application relates generally to the field of smokeless tobacco products.

Background

Cigarettes, cigars and pipes are popular smoking articles that employ tobacco in various forms. Such smoking articles are used by heating or burning tobacco, and aerosol (e.g., smoke) is inhaled by the smoker. Tobacco also may be enjoyed in a so-called “smokeless” form. Particularly popular smokeless tobacco products are employed by inserting some form of processed tobacco or tobacco-containing formulation into the mouth of the user.

Various types of smokeless tobacco products, ingredients and processing methodologies are set forth in U.S. Pat. No. 1,376,586 to Schwartz; U.S. Pat. No. 3,696,917 to Levi; U.S. Pat. No. 4,513,756 to Pittman et al.; U.S. Pat. No. 4,528,993 to Sensabaugh, Jr. et al.; U.S. Pat. No. 4,624,269 to Story et al.; U.S. Pat. No. 4,991,599 to Tibbetts; U.S. Pat. No. 4,987,907 to Townsend; U.S. Pat. No. 5,092,352 to Sprinkle, III et al.; U.S. Pat. No. 5,387,416 to White et al.; U.S. Pat. No. 6,668,839 to Williams; U.S. Pat. No. 6,834,654 to Williams; U.S. Pat. No. 6,953,040 to Atchley et al.; U.S. Pat. No. 7,032,601 to Atchley et al.; and U.S. Pat. No. 7,694,686 to Atchley et al.; US Pat. Pub. Nos. 2004/0020503 to Williams; 2005/0115580 to Quinter et al.; 2006/0191548 to Strickland et al.; 2007/0062549 to Holton, Jr. et al.; 2007/0186941 to Holton, Jr. et al.; 2007/0186942 to Strickland et al.; 2008/0029110 to Dube et al.; 2008/0029116 to Robinson et al.; 2008/0173317 to Robinson et al.; 2008/0196730 to Engstrom et al.; 2008/0209586 to Neilsen et al.; 2008/0305216 to Crawford et al.; 2009/0065013 to Essen et al.; 2009/0293889 to Kumar et al.; 2010/0291245 to Gao et al; and 2011/0139164 to Mua et al.; PCT WO 04/095959 to Arnarp et al. and WO 2010/132444 A2 to Atchley, each of which is incorporated herein by reference.

Certain commercially available smokeless tobacco products, such as products commonly referred to as “snus,” comprise ground tobacco materials incorporated within sealed pouches. The pouches are typically a nonwoven fleece material containing pasteurized tobacco. Representative types of snus products are manufactured in Europe, for example in Sweden by or through companies such as Swedish Match AB, Fiedler & Lundgren AB, Gustavus AB, Skandinavisk Tobakskompagni A/S, and Rocker Production AB. Snus products available in the U.S.A. are marketed, for example, under the trade names Camel Snus Frost, Camel Snus Original and Camel Snus Spice by R. J. Reynolds Tobacco Company. Representative smokeless tobacco products also are marketed under the trade names Oliver Twist by House of Oliver Twist A/S; Copenhagen, Skoal, SkoalDry, Rooster, Red Seal, Husky, and Revel by U.S. Smokeless Tobacco Co.; “taboka” by Philip Morris USA; and Levi Garrett, Peachy, Taylor's Pride, Kodiak, Hawken Wintergreen, Grizzly, Dental, Kentucky King, and Mammoth Cave by Conwood Sales Co., L.P. See also, for example, Bryzgalov et al., 1N1800 Life Cycle Assessment, Comparative Life Cycle Assessment of General Loose and Portion Snus (2005). In addition, certain quality standards associated with snus manufacture have been assembled as a so-called GothiaTek standard.

Various types of snus products, as well as components for those products and methods for processing components associated with those products, have been proposed. See, for example, U.S. Pat. No. 8,067,046 to Schleef et al. and U.S. Pat. No. 7,861,728 to Holton, Jr. et al.; US Pat. Pub. Nos. 2004/0118422 to Lundin et al.; 2008/0202536 to Torrence et al.; 2009/0025738 to Mua et al.; 2010/0180087 to Gee et al.; 2010/0218779 to Zhuang et al.; 2010/0294291 to Robinson et al.; 2010/0300465 to Zimmermann; 2011/0061666 to Dube et al.; 2011/0303232 to Williams et al.; 2012/0067362 to Mola et al.; 2012/0085360 to Kawata et al.; 2012/0103353 to Sebastian et al.; 2012/0247492 to Kobal et al.; 2014/0190497 to Dube et al.; 2014/0255452 to Reddick et al. and 2015/0068545 to Moldoveanu et al.; and PCT Pub. Nos. WO 05/063060 to Atchley et al. and WO 08/56135 to Onno; each of which is incorporated herein by reference.

To provide a variety of products having different taste characteristics, smokeless tobacco products, such as snus products, are often treated with a variety of flavorants and other flavor enhancing materials. For instance, flavorants may be added to the ground tobacco materials and/or the sealed pouches containing the tobacco materials. A common problem encountered with the application of flavorants to smokeless tobacco products is the loss of flavor over time. For instance, smokeless tobacco products often provide an initial release of flavor when inserted into the mouth of the user, but may experience a loss of flavor before the consumer has an opportunity to consume the product to a desired end.

Another common problem encountered with the application of flavorants to smokeless tobacco products is a delayed release of flavor. Flavorants are typically applied directly to the tobacco materials, such that consumers may not experience the flavor applied to the tobacco materials until portions are saturated with saliva in the mouth of the user, causing some of the components of the flavored tobacco material to pass (e.g., diffuse) through the associated pouch. It would therefore be desirable to provide a smokeless tobacco product having an instant and/or sustainable release of flavor during use.

### SUMMARY OF THE DISCLOSURE

According to a first aspect of the present disclosure, a container for a smokeless tobacco product includes a liquid-permeable pouch and a capsule coupled to the liquid-permeable pouch and containing an additive. The capsule releases the additive in response to a trigger condition associated with use of the smokeless tobacco product.

According to a second aspect, a container for a smokeless tobacco product includes a liquid-permeable pouch and a plurality of capsules coupled to the liquid-permeable pouch. The plurality of capsules includes one or more first capsules containing a first additive. The one or more first capsules release the first additive in response to a first trigger condition associated with use of the smokeless tobacco product. The plurality of capsules also includes one or more second capsules containing a second additive. The one or more second capsules release the second additive in response to a second trigger condition associated with use of the smokeless tobacco product. The plurality of capsules further includes one or more third capsules containing a third additive. The one or more third capsules release the third additive in response to a third trigger condition associated with use of the smokeless tobacco product.

According to a third aspect, a method for manufacturing a container for a smokeless tobacco product includes providing a fleece material configured to allow a portion of a tobacco material to pass through, applying an adhesive to an outer surface of the fleece material, and coupling a plurality of microcapsules to the fleece material by applying the plurality of microcapsules to the adhesive. The plurality of microcapsules each contain an additive. The plurality of microcapsules release the additive in response to a trigger condition associated with use of the smokeless tobacco product.

### BRIEF DESCRIPTION OF THE DRAWINGS

Exemplary embodiments of the present application will now be described, by way of example only, with reference to the accompanying diagrammatic drawings, in which:

FIG. 1 is a perspective view of a smokeless tobacco product, according to an exemplary embodiment.

FIG. 2 is a cross-sectional view of the smokeless tobacco product of FIG. 1, taken along line 2-2.

FIG. 3 is a flow chart of a process for providing a container for a smokeless tobacco product, according to an exemplary embodiment.

### DETAILED DESCRIPTION

The present disclosure now will be described more fully hereinafter with reference to the accompanying drawings, in which some, but not all aspects of the disclosure are shown. Indeed, the disclosure may be embodied in many different forms and should not be construed as limited to the aspects set forth herein. Rather, these aspects are provided so that this disclosure will be thorough and complete, will fully convey the scope of the disclosure to those skilled in the art, and will satisfy applicable legal requirements. Like numbers refer to like elements throughout.

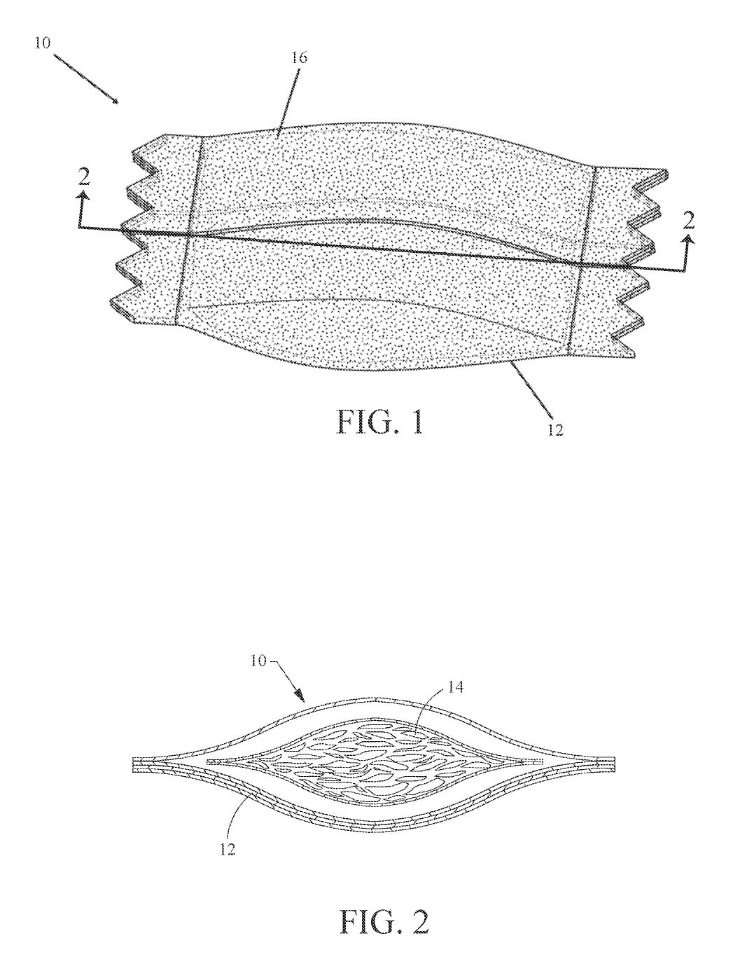

Referring to FIGS. 1 and 2, a smokeless tobacco product 10 is shown, according to an exemplary embodiment. The tobacco product 10 is shown as a snus-type product in FIGS. 1 and 2. However, the tobacco product 10 may be another type of pouched smokeless tobacco product (e.g., snuff) in other embodiments. The tobacco product 10 includes a moisture-permeable container in the form of a pouch 12. A solid tobacco material 14 is contained within the pouch 12. The tobacco product 10 is typically used by placing the pouch 12 containing the tobacco material 14 in the mouth of a user. During use, saliva in the mouth of the user causes some of the components of the tobacco material 14 to pass (e.g., diffuse) through the water-permeable pouch 12 and into the mouth of the user, providing the user with tobacco flavor.

During use by the user, portions of the tobacco material 14 are allowed to pass through the pouch 12. Such pouch materials may have the form of a mesh, screen, perforated paper, permeable fabric, or the like. In some embodiments, the pouch 12 is made of a fleece fabric material. The pouch 12 may also be configured to undergo a controlled dispersion or dissolution. For example, pouch material manufactured from a mesh-like form of rice paper, or perforated rice paper, may dissolve in the mouth of the user. As a result, the pouch 12 and tobacco formulation each may undergo complete dispersion within the mouth of the user during normal conditions of use. Other exemplary pouch materials may be manufactured using water dispersible film forming materials (e.g., binding agents such as alginates, carboxymethylcellulose, xanthan gum, pullulan, and the like), as well as those materials in combination with materials such as ground cellulosics (e.g., fine particle size wood pulp). Preferred pouch materials, though water dispersible or dissolvable, may be designed and manufactured such that under conditions of normal use, a significant amount of the tobacco formulation contents permeate through the pouch material prior to the time that the pouch undergoes loss of its physical integrity.

The tobacco material 14 may be provided in a shredded, ground, granulated, fine particulate or powder form. The tobacco material 14 also can be processed, blended, formulated, combined and mixed with other materials or ingredients. For example, the tobacco material 14 can incorporate salts, sweeteners, binders, colorants, pH adjusters or buffers, fillers, flavoring agents, disintegration aids, antioxidants, humectants, and preservatives. Typically, for certain embodiments, the amount of the tobacco material 14 within the tobacco product 10 can be, on a dry weight basis, at least about 30 mg, often at least about 40 mg, and frequently at least about 45 mg; while that amount typically is less than about 200 mg, often less than about 150 mg, and frequently less than about 100 mg. The tobacco material 14 can have the form of processed tobacco parts or pieces, cured and aged tobacco in essentially natural lamina or stem form, a tobacco extract, extracted tobacco pulp (e.g., using water as a solvent), or a mixture of the foregoing (e.g., a mixture that combines extracted tobacco pulp with granulated cured and aged natural tobacco lamina).

The tobacco product 10 also includes a plurality of microcapsules 16 coupled (e.g., applied, adhered, connected, etc.) to the pouch 12. In an exemplary embodiment, the microcapsules 16 are coupled to the pouch 12 by an adhesive polymer. For instance, the pouch 12 may be coated with a food-grade biodegradable polymer, such as polycaprolactone. The microcapsules 16 are then coupled to the pouch 12 by applying the microcapsules 16 to the adhesive polymer. The microcapsules 16 may be applied by printing or spraying the microcapsules 16 onto the adhesive polymer. The microcapsules 16 may also be applied using an air bath.

The microcapsules 16 include an inner or core region encapsulated by an outer shell region. The inner region includes a payload of an additive or ingredient. The additive may be adapted for enhancing one or more sensory characteristics of the smokeless tobacco product 10, such as taste, mouthfeel, moistness, coolness/heat, and/or fragrance. The additive may also be adapted for adding an additional functional quality to the smokeless tobacco product 10, such as addition of an antioxidant or immune system enhancing function. The microcapsules 16 physically separate or segregate, to a certain extent, the additive from one or more other components of the tobacco product 10. The functional advantage of such a separation can vary, but typically involves the minimization or elimination of chemical interaction between the additive and other components of the tobacco product 10 during conditions of normal storage and/or use. Separation of certain additives can thus enhance storage stability of the resulting tobacco product 10 and/or preserve the desirable sensory characteristics of the product 10. Although the tobacco product 10 is shown to include microcapsules 16, the means of separation can take various forms, including use of the additive in various forms such as beads, pellets, rods, films, strands, layered or laminate structures, sheets, strips, or other shaped items. The additive can also be dispersed within a matrix material and shaped into a desired form.

In some embodiments, the additive comprises a flavorant configured to enhance the flavor of the smokeless tobacco product during use. Example flavorants that can be used as additives are components, or suitable combinations of those components, that act to alter the bitterness, sweetness, sourness, or saltiness of the smokeless tobacco product 10, enhance the perceived dryness or moistness of the tobacco product 10, or the degree of tobacco taste exhibited by the product 10. Types of flavorants include salts (e.g., sodium chloride, potassium chloride, sodium citrate, potassium citrate, sodium acetate, potassium acetate, and the like), natural sweeteners (e.g., fructose, sucrose, glucose, maltose, mannose, galactose, lactose, and the like), artificial sweeteners (e.g., sucralose, saccharin, aspartame, acesulfame K, neotame, and the like); and mixtures thereof. Flavorants may be natural or synthetic, and the character of these flavors imparted thereby may be described, without limitation, as fresh, sweet, herbal, confectionary, floral, fruity or spice. Specific types of flavors include, but are not limited to, vanilla, coffee, chocolate/cocoa, cream, mint, spearmint, menthol, peppermint, wintergreen, eucalyptus, lavender, cardamon, nutmeg, cinnamon, clove, cascarilla, sandalwood, honey, jasmine, ginger, anise, sage, licorice, lemon, orange, apple, peach, lime, cherry, strawberry, and any combinations thereof. See also, Leffingwell et al., Tobacco Flavoring for Smoking Products, R. J. Reynolds Tobacco Company (1972), which is incorporated herein by reference. Flavorants also may include components that are considered moistening, cooling or smoothening agents, such as eucalyptus. These flavors may be provided neat (i.e., alone) or in a composite (e.g., spearmint and menthol, or orange and cinnamon). Composite flavors may be combined in one of the microcapsules 16 as a mixture, or as separate components of separate microcapsules 16.

In one embodiment, the additive comprises a tobacco-based flavorant composition, such as a flavorant comprising particulate tobacco material or a tobacco extract (e.g., an aqueous tobacco extract in solid form). Any of the kinds of tobacco material set forth herein could be used as a microencapsulated flavorant. The use of a microencapsulated tobacco flavorant can provide the smokeless tobacco product 10 with instant and/or extended release flavor characteristics. Some forms of smokeless tobacco products deliver a strong sensory profile. By microencapsulating a portion of the tobacco material 14 in the product 10, a milder sensory experience can be achieved. Microencapsulation of a tobacco flavorant can also extend the sensory experience by providing a slow continuous release of tobacco flavor over time as the product 10 resides in the mouth. Preferred microencapsulated tobacco flavorants will provide extended release of the tobacco flavorant under conditions of normal use of the smokeless tobacco product 10.

The outer shell or coating of the microcapsules 16 serves as a barrier between the payload (i.e., the additive) and the tobacco material 14 of the smokeless tobacco product 10. In example embodiments, the outer shell may be made from any of gelatin, sodium alginate, ethyl cellulose, carrageenan, cellulose acetate, and the like. The additive in the core region of the microcapsules 16 is released under certain conditions of product use (e.g., a use condition, trigger condition, trigger mechanism, etc.). For instance, the outer shell may undergo some type of physical destruction, breakage, or other loss of physical integrity (e.g., through disintegration, softening, crushing, application of pressure, or the like) in response to a trigger condition associated with the product 10. Such a release of the additive may alter or enhance the flavor or other sensory characteristics of the product 10, extend the period of time that a user may enjoy the product 10, or provide other functional advantages. The trigger conditions associated with release of the additive may vary based on the characteristics of the pouch 12, the tobacco material 14, the microcapsules 16, and the additive. The trigger conditions may also vary based the intended use of the product 10.

In some embodiments, one or more of the microcapsules 16 are configured to release the additive in response to a change in moisture. For example, contact of the microcapsules 16 with moisture present in the user's mouth may cause the microcapsules 16 to soften, lose their physical integrity, and release the additive within the user's mouth. For certain tobacco products, such as those incorporating snus-type tobacco materials, the moisture content of the tobacco material (e.g., tobacco material 14), as present within the pouch prior to insertion into the mouth of the user, may exceed 20 percent by weight, and often may exceed 30 percent by weight. For example, a representative snus-type product may include a tobacco material exhibiting a moisture content of approximately 25 percent by weight to approximately 50 percent by weight, preferably approximately 30 percent by weight to approximately 40 percent by weight. In one embodiment, the tobacco product 10 is a snus-type product, and the tobacco material 14 has a moisture content of approximately 33 percent by weight. In this embodiment, one or more of the microcapsules 16 is configured to release the additive when the moisture content at the one or more microcapsules 16 reaches a predetermined moisture content greater than 33 percent by weight (e.g., 35 percent, 40 percent, 50 percent, etc.).

The moisture content of the tobacco product 10 prior to use by a consumer of the product 10 may vary. In some embodiments, the moisture content of the tobacco material 14, as present within the pouch prior to insertion into the mouth of the user, is less than about 55 percent by weight, generally is less than about 50 percent by weight, and often is less than about 45 percent by weight. Certain types of tobacco materials have moisture contents, prior to use, of less than about 15 percent by weight, frequently less than about 10 percent by weight, and often less than about 5 percent by weight. In one embodiment, the tobacco product 10 is a pouched moist snuff product, and the tobacco material 14 has a moisture content of approximately 50 percent by weight. In this embodiment, one or more of the microcapsules 16 is configured to release the additive when the moisture content at the one or more microcapsules 16 reaches a predetermined moisture content greater than 50 percent by weight (e.g., 51 percent, 55 percent, 60 percent, 65 percent, etc.).

In some embodiments, one or more of the microcapsules 16 are configured to release the additive in response to a change in temperature. For example, contact of the microcapsules 16 with the raised temperature of the user's mouth (e.g., the user's saliva) may cause one or more of the microcapsules 16 to soften, lose their physical integrity, and release the additive within the user's mouth. In one embodiment, one or more of the microcapsules 16 is configured to release the additive when the temperature at the one or more microcapsules 16 is at or near (e.g., greater than) a temperature typical of a user's mouth (e.g., approximately 37 degrees Celsius). In other embodiments, one or more of the microcapsules 16 is configured to release the additive when the temperature of the product 10 (e.g., the one or more microcapsules 16, the tobacco material 14) changes (e.g., is raised, is lowered) by at least a predetermined amount (e.g., 1 degree Celsius, 2 degrees Celsius, 5 degrees Celsius, etc.).

In some embodiments, one or more of the microcapsules 16 are configured to release the additive in response to a change in pH. The pH of the tobacco product 10 (e.g., the tobacco material 14, the pouch 12) can vary. Typically, the pH of the tobacco material 14 is at least approximately 6.5, and preferably at least approximately 7.5. Typically, the pH of that tobacco material 14 will not exceed approximately 9, and often will not exceed approximately 8.5. A representative tobacco material exhibits a pH of approximately 6.8 to approximately 8.2. In one embodiment, one or more of the microcapsules 16 is configured to release the additive when the pH at the one or more microcapsules 16 is at or near (e.g., greater than) a pH typical of a user's mouth (e.g., approximately 5.6 to 7.9). In other embodiments, one or more of the microcapsules 16 is configured to release the additive when the pH of the product 10 (e.g., the one or more microcapsules 16, the tobacco material 14) changes (e.g., is raised, is lowered) by at least a predetermined amount (e.g., 0.1, 0.5, 1.0, etc.).

The microcapsules 16 may also be configured to release the additive in response to a digestive enzyme typically found in the mouth of a user (e.g., amylase). If the tobacco product 10 includes an amount of the digestive enzyme, one or more of the microcapsules 16 may be configured to release the additive in response to an increase in the amount of the digestive enzyme at or near the one or more microcapsules 16.

In an example embodiment, each of the plurality of microcapsules 16 provided on the tobacco product 10 is configured to release an associated flavorant based on the same trigger condition. In this embodiment, the microcapsules 16 are intended to provide a single burst of flavor simultaneously to the user in response to a condition of product use (i.e., in a single stage). For instance, the trigger condition may include a change in moisture, temperature, or pH, a digestive enzyme, or some other trigger condition associated with use of the tobacco product 10. The tobacco product 10 may also provide an initial flavor to the user in this embodiment. For example, a flavorant may be applied to the pouch 12 or the tobacco material 14 that is provided to the user (i.e., without use of an associated microcapsule) upon insertion into the user's mouth. The flavorant contained within the microcapsules 16 is then released in response to a trigger condition that is associated with continued use of the product 10 (e.g., a temperature, moisture, pH, enzyme, etc. associated with prolonged use), providing an additional burst of flavor to the user during use of the product 10.

In other embodiments, the plurality of microcapsules 16 includes more than one type of microcapsule, with each type of microcapsule configured to release its associated additive in response to a different trigger condition. In one example embodiment, the plurality of microcapsules 16 includes a first microcapsule configured to release a flavorant (or another additive) in response to a first trigger condition, a second microcapsule configured to release the flavorant in response to a second trigger condition, and a third microcapsule configured to release the flavorant in response to a third trigger condition. In this embodiment, the microcapsules 16 are intended to provide multiple bursts (i.e., multiple stages) of flavor to the user during use of the product 10. The trigger conditions are selected such that, during use of the product 10, the first trigger condition is intended to occur first, the second trigger condition is intended to occur next, and the third trigger condition is intended to occur last. As an example, the first trigger condition may be a temperature of approximately 33 degrees Celsius, the second condition a temperature of approximately 35 degrees Celsius, and the third condition a temperature of approximately 37 degrees Celsius. As another example, the first trigger condition may be a moisture content of greater than 40 percent by weight, the second trigger condition a temperature of approximately 37 degrees Celsius, and the third trigger condition saturation by a digestive enzyme such as amylase. The additive contained within each of the three types of microcapsules 16 may be the same, or the microcapsules 16 may include different types of additives.

The microcapsules 16 may be uniform or varied in size, weight, and shape, and such properties of the microcapsules 16 will depend upon the desired properties of the smokeless tobacco product 10. The microcapsules 16 may be of various shape, including being generally spherical, rectilinear, oblong, elliptical, or oval. The microcapsules 16 may have diameters of less than about 100 microns, such as microcapsules having diameters in the range of about 1 to about 40 microns, or about 1 micron to about 20 microns. The total weight of the microcapsules 16 applied to the pouch 12 may vary, but is typically greater than about 10 mg, often greater than about 20 mg, and can be greater than about 30 mg. The total weight of the microcapsules 16 is typically less than about 200 mg, often less than about 100 mg, and can be less than about 50 mg.

The number of the microcapsules 16 applied to the pouch 12 can vary, depending upon factors such as the size of the microcapsules 16, the character or nature of the additive in the payload, the desired attributes of the smokeless tobacco product 10, and the like. The number of microcapsules 16 applied to the pouch 12 can exceed about 5, can exceed about 10, can exceed about 20, can exceed about 40, and can even exceed about 100. In certain embodiments, the number of microcapsules 16 can be greater than about 500, and even greater than about 1,000.

The outer wall or shell material and solvents used to form the microcapsules 16 can vary. Classes of materials that are typically used as wall or shell materials include proteins, polysaccharides, starches, waxes, fats, natural and synthetic polymers, and resins. Exemplary materials for use in the microencapsulation process used to form the microcapsules 16 include gelatin, acacia (gum arabic), polyvinyl acetate, potassium alginate, carob bean gum, potassium citrate, carrageenan, potassium polymetaphosphate, citric acid, potassium tripolyphosphate, dextrin, polyvinyl alcohol, povidone, dimethylpolysiloxane, dimethyl silicone, refined paraffin wax, ethylcellulose, bleached shellac, modified food starch, sodium alginate, guar gum, sodium carboxymethylcellulose, hydroxypropyl cellulose, sodium citrate, hydroxypropylmethylcellulose, sodium ferrocyanide, sodium polyphosphates, locust bean gum, methylcellulose, sodium trimetaphosphate, methyl ethyl cellulose, sodium tripolyphosphate, microcrystalline wax, tannic acid, petroleum wax, terpene resin, tragacanth, polyethylene, xanthan gum, and polyethylene glycol.

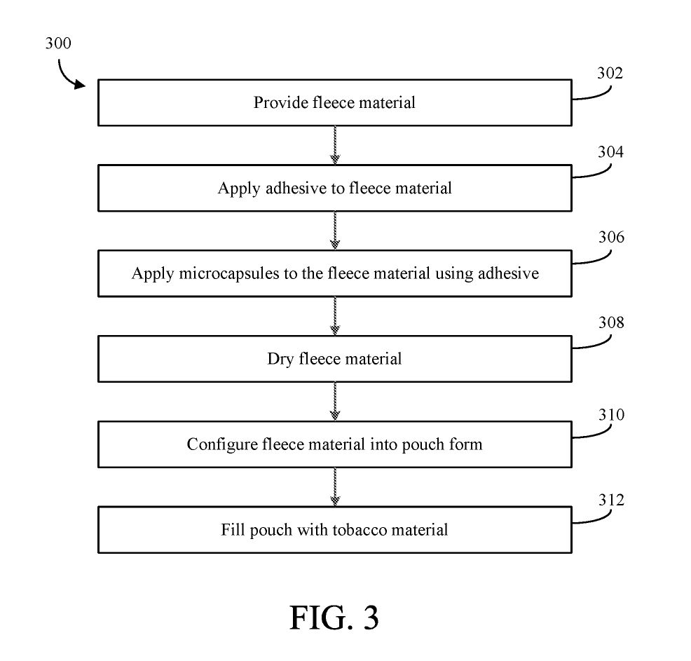

Referring now to FIG. 3 a process 300 is shown for manufacturing the pouch 12, according to an exemplary embodiment. A fleece material for the pouch 12 is provided at 302. Although a fleece material is used in this embodiment, in other embodiments the pouch 12 may be made from any other material described herein. The material for the pouch 12 may be provided by cutting the fleece material from a sheet of said material in the shape of the pouch 12. An adhesive is applied to an outer surface of the fleece material at 304. The adhesive may be an adhesive polymer that is suitable for ingestion by the user, including a food-grade biodegradable polymer, such as polycaprolactone. The adhesive may be sprayed or otherwise applied onto the entire outer surface of the fleece material.

The microcapsules 16 are applied to the adhesive at 306. The adhesive is configured to adhere to the microcapsules 16, coupling the microcapsules 16 to the fleece material. The microcapsules 16 may be applied to the adhesive by printing or spraying the microcapsules 16 onto the adhesive. The microcapsules 16 may also be applied using an air bath. In an exemplary embodiment, the microcapsules 16 are applied to the adhesive in a manner intended to avoid the occurrence of the trigger condition, and thus avoid release of the additive contained by the microcapsules 16. The fleece material, including the applied adhesive, is dried at 308. The fleece material may also be dried by an air bath. The fleece material is configured into the shape of the pouch 12 at 310. The pouch 12 is filled with tobacco material at 312.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the tobacco product 10 as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, manufacturing processes, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A container for a smokeless tobacco product, the container comprising:
a liquid-permeable pouch; and
a capsule coupled to the liquid-permeable pouch and containing an additive, the capsule releasing the additive in response to a trigger condition associated with use of the smokeless tobacco product.

2. The container of claim 1, wherein the additive comprises a flavorant configured to enhance the flavor of the smokeless tobacco product during use.

3. The container of claim 2, wherein the additive is the sole flavor delivery mechanism for the smokeless tobacco product.

4. The container of claim 1, further comprising an adhesive polymer coating an outer surface of the liquid-permeable pouch, the adhesive polymer coupling the capsule to the liquid-permeable pouch.

5. The container of claim 1, wherein the capsule comprises a microcapsule including a core region encapsulated by an outer shell region, the core region including the additive, the outer shell region releasing the additive from the core region by loss of physical integrity in response to the trigger condition.

6. The container of claim 5, wherein the trigger condition is based on at least one of a moisture, a temperature, and a pH at or near the outer shell region.

7. The container of claim 1, further comprising a tobacco material contained within the liquid-permeable pouch, wherein the capsule physically segregates the additive from the liquid-permeable pouch and the tobacco material prior to occurrence of the trigger condition.

8. A container for a smokeless tobacco product, the container comprising:
a liquid-permeable pouch; and
a plurality of capsules coupled to the liquid-permeable pouch, the plurality of capsules comprising:
one or more first capsules containing a first additive, the one or more first capsules releasing the first additive in response to a first trigger condition associated with use of the smokeless tobacco product;
one or more second capsules containing a second additive, the one or more second capsules releasing the second additive in response to a second trigger condition associated with use of the smokeless tobacco product; and
one or more third capsules containing a third additive, the one or more third capsules releasing the third additive in response to a third trigger condition associated with use of the smokeless tobacco product.

9. The container of claim 8, wherein each of the additives is a flavorant configured to enhance the flavor of the smokeless tobacco product during use.

10. The container of claim 9, wherein the first trigger condition, the second trigger condition and the third trigger positions are related to each other such that the first trigger condition occurs after introduction to the mouth of a user of the smokeless tobacco product, the second trigger condition occurs after the first trigger condition, and the third trigger condition occurs after the second trigger condition.

11. The container of claim 10, wherein each of the trigger conditions is related to the same one of a moisture, a temperature, and a pH associated with the smokeless tobacco product.

12. The container of claim 10, wherein the plurality of capsules comprises equal amounts of each of the one or more first capsules, the one or more second capsules, and the one or more third capsules.

13. The container of claim 8, further comprising an adhesive polymer coating an outer surface of the liquid-permeable pouch, the adhesive polymer coupling the plurality of capsules to the liquid-permeable pouch.

14. The container of claim 8, wherein each of the plurality of capsules comprises a microcapsule comprising a core region encapsulated by an outer shell region, the core region including the respective additive, the outer shell region releasing the respective additive from the core region by loss of physical integrity in response to the respective trigger condition.

15. The container of claim 8, further comprising a tobacco material contained within the liquid-permeable pouch, wherein the plurality of capsules physically segregate the additives from the liquid-permeable pouch and the tobacco material prior to occurrence of the respective trigger condition.

16. A method for manufacturing a container for a smokeless tobacco product, the method comprising:
providing a fleece material configured to allow a portion of a tobacco material to pass through;
applying an adhesive to an outer surface of the fleece material; and
coupling a plurality of microcapsules to the fleece material by applying the plurality of microcapsules to the adhesive, the plurality of microcapsules each containing an additive, the plurality of microcapsules releasing the additive in response to a trigger condition associated with use of the smokeless tobacco product.

17. The method of claim 16, wherein the adhesive comprises a food-grade biodegradable polymer adhesive.

18. The method of claim 16, wherein the plurality of microcapsules are applied to the adhesive by spraying or printing the plurality of microcapsules to the adhesive.

19. The method of claim 16, further comprising:
drying the fleece material, including the adhesive.

20. The method of claim 19, further comprising:
configuring the fleece material into a pouch; and
filling the pouch with a tobacco material.
